(19) United States
(12) Patent Application Publication
(10) Pub. No.: US 2009/0218453 A1
(43) Pub. Date: Sep. 3, 2009

(54) PIPE SUPPORT BLOCK

(76) Inventor: Michael J. Brenner, Kitchener (CA)

Correspondence Address: BENNETT JONES LLP, 3400 ONE FIRST CANADIAN PLACE, PO BOX 130, TORONTO, ON, M5X 1A4, CA

(21) Appl. No.: 12/040,345

(22) Filed: Feb. 29, 2008

(51) Int. Cl. F16L 3/08

(52) U.S. Cl. 248/74.1; 248/49

(57) ABSTRACT

A support block assembly is provided for securing pipes, conduit, wire and other structures above a surface such as a roof. The support block assembly comprises a support block, a plurality of protrusions and a base that can be attached to the support block by interfacing with the protrusions. According to another embodiment, the support block includes a strap molded to the side of the support block. The strap can be removed and inserted into apertures on the top surface of the support block to secure a structure that is resting on the top surface of the support block.

### FIELD OF THE INVENTION

The present invention relates to support devices, and more particularly to a device suitable for supporting (and securing) pipes, conduit, wire and the like.

### BACKGROUND OF THE INVENTION

In the modern world many services such as electricity, gas, water, etc. are provided to buildings that are remotely located from the source of the services. These services, and others, are often delivered from remote locations to customers using piping, ductwork, conduit and the like. In addition, buildings have internal systems such as heating, ventilation, air conditioning, plumbing, etc. that also require the use of piping, conduit and other elongated structures. These pipes are permanently secured in a specific location such that their position and alignment does not change and/or they are protected from damage from the elements and human activity.

One of the ways this is accomplished is by placing pipes on support blocks that are mounted upon roofs, and sometimes on indoor surfaces, to secure the position and alignment of these pipes a certain distance above a roof or surface. Pipes are often mounted a certain distance above roofs for convenience, for increased safety or because the laws of a jurisdiction mandate such an arrangement. The pipes may rest directly on the support blocks or upon a fixture that itself is mounted on the top of a support block.

Several variations of support blocks are already used in the construction industry; however, the known support blocks all suffer from some form of limitation. As an example, it is commonly known in the prior art that wooden blocks may be used to support piping. Wooden blocks, however, have limitations. One limitation is that wooden blocks exposed to the elements will deteriorate or rot over time, thus requiring periodic replacement. If the wooden blocks are not replaced then damage may result to both the pipe resting on the wooden block and perhaps the roof as well, possibly further resulting in an interruption in the delivery of a service and costly repairs. Another limitation is related to the weight of wooden blocks and how they are purchased. Contractors will typically buy wooden tiles that are cut into individual blocks, requiring both the heavy wooden tiles and specialized equipment to be lifted to a roof. Even if the wooden tiles are cut into individual blocks before they are lifted to a roof, the weight of wooden blocks can be significant.

Support blocks made of synthetic materials such as plastic are also known in the art but the known designs also suffer limitations. Some synthetic material support blocks have a base permanently affixed to the bottom of the support block thus preventing the stacking of two or more blocks. Blocks that cannot be stacked will take up more space on a lifting device, which will increase the time and money required to lift the support blocks to a roof. Other known synthetic material support blocks contain an internal support structure for added strength, but the structure prevents or hinders the stacking of multiple blocks.

Accordingly, there remains a need for improvements.

### BRIEF SUMMARY OF THE INVENTION

The present invention relates to an apparatus for supporting structures, such as a pipe, on a roof or other surface. In one aspect, the apparatus comprises two component parts: a support block and a base.

In an embodiment of the present invention, the apparatus comprises a support member and a base member. The support member includes a support surface. A pipe is placed on the support surface. According to an embodiment the apparatus includes a strap that is attached to the support member. The strap is removed, and each end of the strap is inserted into apertures on the top surface of the support member to secure the pipe into place.

According to an embodiment, there is provided a support block, the support block comprises: a lower portion and an upper portion that includes a support surface, the support surface includes a plurality of protrusions which are configured to engage a base member.

According to another embodiment, there is provided a support block assembly, the support block assembly comprises: a lower portion and an upper portion that includes a support surface, the support surface includes a plurality of protrusions which are engaged to a base member, and a strap which is locked into place on the support surface.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention and in which:

FIG. 1 shows in diagrammatic form a support apparatus or block according to an embodiment of the present invention;

FIG. 2(a) is a bottom view of the support block of FIG. 1; FIG. 2(b) shows a base which can be attached to the support block according to an embodiment of the present invention;

FIG. 3 is a bottom view of the support block of FIG. 2(a) with the base installed;

FIG. 4 shows in diagrammatic form a support block configured to support a pipe according to an embodiment of the present invention.

In the drawings, like elements are indicated by like references.

### DETAILED DESCRIPTION OF THE EMBODIMENTS

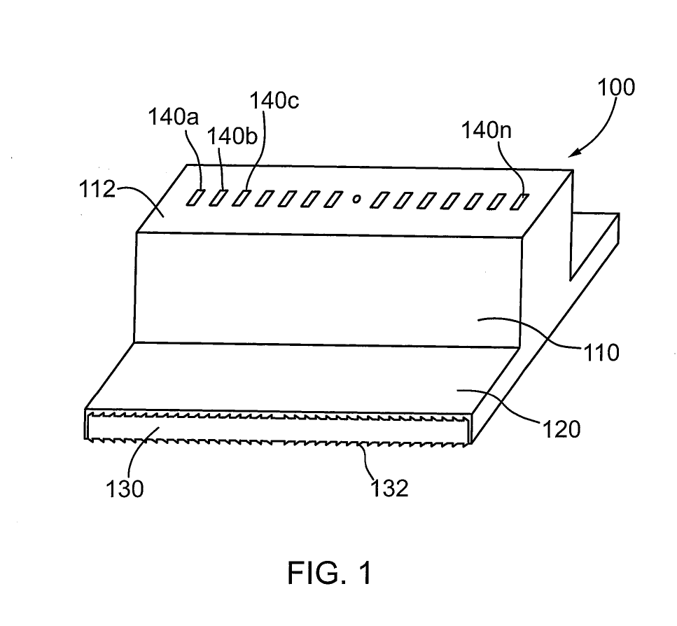

Reference is first made to FIG. 1 which shows in diagrammatic form a support block according to an embodiment of the present invention, and is indicated generally by reference 100.

The term pipe or variations thereof will be used throughout the remaining portions of this description to refer to any structure and it will be appreciated by those skilled in the art that the invention disclosed in this document can be used for several applications and to secure a variety of structures.

The support block 100 depicted in FIG. 1 comprises an upper portion 110, a lower portion 120, and a plurality of slots indicated individually by references 140a, 140b, 140c to 140n. According to an embodiment, the support block 100 includes a strap 130. According to an embodiment, the strap 130 is molded with the support block 100 and attached to the lower portion 120 of the exemplary support block 100 during the molding process in such a way that the strap 130 can be easily removed by an individual. Additional molded strap(s) may be included, for example, during the molding process to other portions of the upper portion 110 or the lower portion 120 of the support block 100. As shown, the support block 100 (i.e. the upper portion 110) includes a support surface 112 which provides a surface for supporting the pipe.

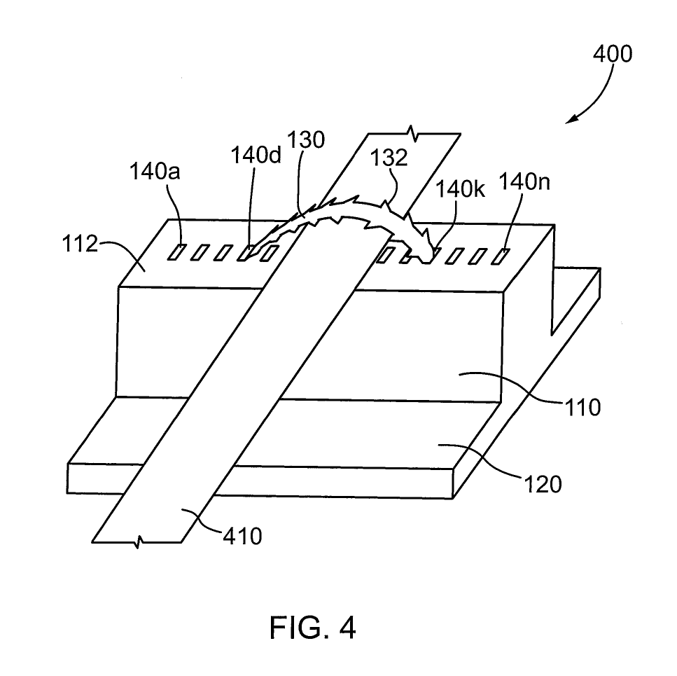

As shown in FIGS. 1 and 4, the strap 130 includes one or more latches or hooks indicated by reference 132. The latches or hooks 132 engage a respective pair of the apertures 140a to 140n. The latches 132 secure or lock each end of the strap 130 into place and may be further tightened to secure an object such as a pipe on the top surface of the block 100. This configuration is further illustrated in FIG. 4.

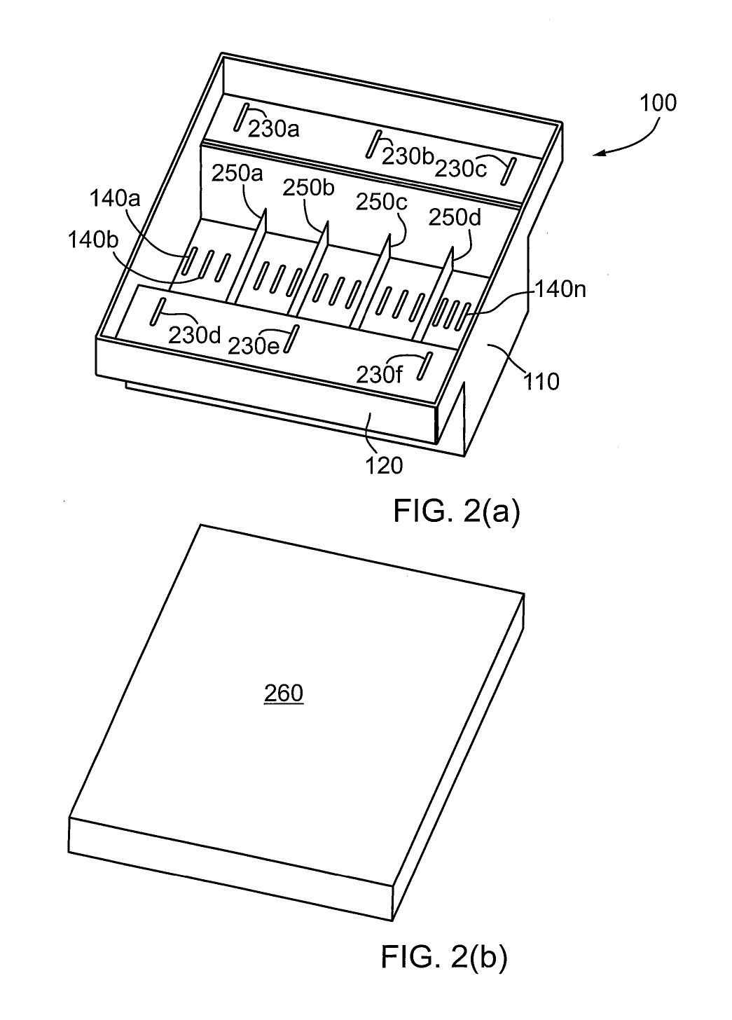

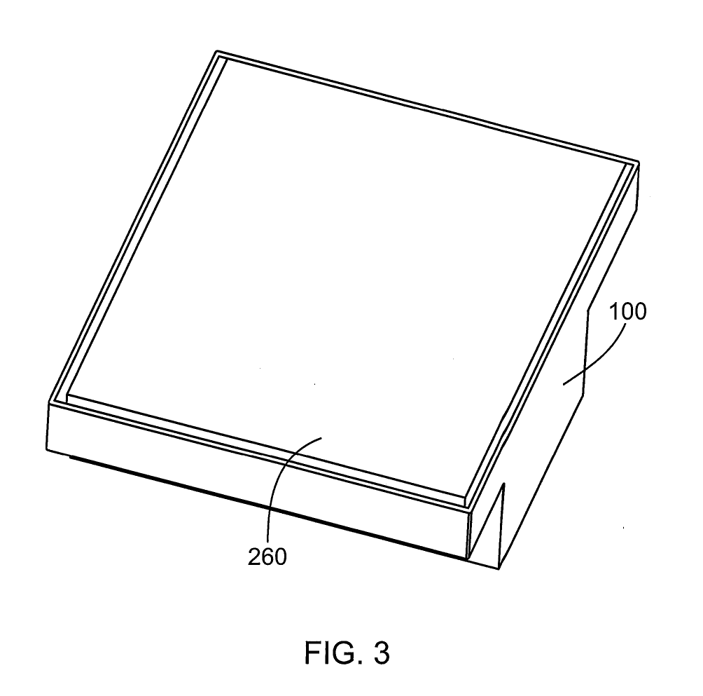

Reference is next made to FIG. 2(a), which shows the underside of the support block 100 in more detail and FIG. 2(b) which shows a base member 260 which can be attached to the support block 100. The support block 100 and the base 260 comprise the component parts of a completed support block assembly as shown in FIG. 3. According to an embodiment and as shown in FIG. 2(a), the support block 100 may include a plurality of protrusions, e.g. spikes, 230, indicated individually by references 230a, 230b, 230c, 230d, 230e and 230f which protrude from the underside of the lower portion 120. The support block 100 also includes a plurality of ribs 250, indicated individually by references 250a, 250b, 250c and 250d. The ribs 250 are configured to increase the amount of weight that can be supported by the support block 100. It will be appreciated that any number of ribs can be used to strengthen the support block 100. As shown in FIG. 2(a), the inside of the support block 100 is generally hollow, allowing for several support blocks 100 to be stacked on top of each other.

According to an embodiment, the base 260 comprises a material, such as closed cell foam, that can be punctured by protrusions 230a, 230b, 230c, 230d, 230e and 230f. In practice, a technician presses the base 260 against the underside of the support block 100 as shown in FIG. 3. Because the base 260 is not pre-attached to the support block 100, several support blocks 100 can be stacked on top of each other and easily assembled to a corresponding base member 260 on site where the support block assemblies (i.e., support blocks 100 with attached bases 260) are to be installed.

Reference is next made to FIG. 3, which shows the support block 100 with the base member 260 attached to the bottom. As described above, the base 260 is attached to the underside of support block 100 via the protrusions 230a to 230f (FIG. 2(a)) according to an embodiment.

Reference is next made to FIG. 4, which illustrates, according to an embodiment, the use of the support block assembly (i.e., support block 100 with attached base 260) to support (and secure) a pipe at an installation site, typically the roof of a building. As shown, the pipe 410 rests on the support surface 112. The strap 130 has been removed from the lower portion 120 by a technician and then one end of the strap 130 is inserted into the slot 140d and the other end of the strap 130 is inserted into the slot 140k. The latches or hooks 132 on the strap 130 are configured to lock the strap 130 into position. The strap 130 can be further tightened to secure or lock the pipe 410. At the installation site, the base 260 is generally attached as shown in FIG. 3 before securing the pipe 410. It will be appreciated that in other embodiments of the present invention different slot configurations or apertures may be provided for the strap 130. According to an aspect, the slot configurations are based on the size of the pipe to be secured to the support block assembly.

It will be appreciated by those skilled in the art that other structures and fixtures can be attached to the upper portion 110 of the support block 100 (i.e. support surface 112) using the strap 130. For example, it may be desired to secure a fixture to the support block 100 and then to secure a pipe onto the fixture. Such an arrangement may be desired to support a pipe at a distance higher than the height of the support block 100.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A support block for supporting a pipe, said support block comprising:
a support member comprising a lower portion and an upper portion and said upper portion including a support surface;
said support member being substantially hollow, and said lower portion including a plurality of protrusions;
said plurality of protrusions being configured to engage a base member.

2. The support block as claimed in claim 1, wherein said base member is formed from a material that can be punctured by said protrusions.

3. The support block as claimed in claim 1, wherein said support member includes a reinforcing element.

4. The support block as claimed in claim 3, wherein said reinforcing element comprises one or more ribs.

5. The support block as claimed in claim 1, wherein said support surface includes one or more slots configured to engage a strap.

6. The support block as claimed in claim 5, further including one or more straps detachably connected to said support member, and said one or more straps being configured to engage said one or more slots for securing the pipe to said support surface.

7. The support block as claimed in claim 6, wherein said one or more straps include a latching mechanism configured to lock the strap to said support surface.

8. A support block assembly for supporting a pipe, said support block assembly comprising:
a support member comprising a lower portion and an upper portion and said upper portion including a support surface, said support surface including a plurality of slots;
said support member being substantially hollow, and said lower portion including a plurality of protrusions;
a base member which is engaged to said plurality of protrusions;
one or more straps, said one or more straps engaged to said slots of said support surface.

9. The support block assembly as claimed in claim 8, wherein said base member is formed from a material that can be punctured by said protrusions.

10. The support block assembly as claimed in claim 8, wherein said support member includes a reinforcing element.

11. The support block assembly as claimed in claim 10, wherein said reinforcing element comprises one or more ribs.

12. The support block assembly as claimed in claim 8, wherein said one or more straps include a latching mechanism configured to lock the strap to said slots of said support surface.
